(19) United States
(12) Patent Application Publication
(10) Pub. No.: US 2026/0300193 A1
(43) Pub. Date: Oct. 1, 2026

(54) RESERVATION MANAGEMENT IN STORAGE INTERFACE ADAPTERS OF MULTI-HOST STORAGE SYSTEMS

(71) Applicant: Western Digital Technologies, Inc., San Jose, CA (US)

(72) Inventors: Supriya B.K, Bangalore (IN); Kumar Ranjan, Bangalore (IN)

(21) Appl. No.: 19/089,187

(22) Filed: Mar. 25, 2025

(51) Int. Cl. G06F 13/16; G06F 13/38

(52) U.S. Cl. CPC G06F 13/1663; G06F 13/1689; G06F 13/385

(57) ABSTRACT

Systems, methods, and storage interface controllers for reservation management in multi-host data storage systems are described. The storage interface controllers, such as Non-Volatile Memory Express over Fabric (NVMeoF) adapters, store namespace reservation keys and corresponding reservation host identifiers. The storage interface controllers verify that the host identifier in a connection request matches the reservation host identifier for the namespace before allowing access to the data storage device that hosts the namespace. Multiple storage interface controllers may store and synchronize reservation information and/or get it from migrated data storage devices during initialization to enforce the reservation setting even if the data storage device is moved between enclosures.

### TECHNICAL FIELD

The present disclosure generally relates to storage systems supporting a plurality of hosts and, more particularly, to using storage interface controllers, such as Non-Volatile Memory Express (NVMe) adapters, to manage reservations for improved security among hosts.

### BACKGROUND

Non-Volatile Memory Express over Fabric (NVMeoF) is a protocol that allows for the transfer of data between a host and a storage device over a network, such as Ethernet, Fibre Channel, or InfiniBand. This protocol is designed to leverage the benefits of NVMe, a storage protocol designed for flash, next-generation solid-state drives (SSDs), and other data storage devices, across network fabrics.

In multi-host storage systems, multiple hosts can access the same storage device. This can lead to issues with data consistency, integrity, and security. A namespace is a container for data stored in NVMe data storage devices, and it can be shared among multiple hosts. NVMeoF may implement a reservation feature that enables multiple hosts to connect to the same namespace while reserving different read and write privileges for one or more of the reserving hosts in order to better control the shared access.

Current solutions for managing reservations may have a security vulnerability that relates to data storage devices being moved among different storage enclosures and corresponding NVMe adapters. For instance, when a data storage device that includes namespaces with one or more reservations is moved to a new enclosure, that enclosure has no knowledge of the existing reservations. Another host system may access the reserved namespace based on a connection through the new adapter and may appear to the data storage device to be the registered host. Additionally, the management of reservations across a population of drives can become cumbersome for the host systems as the number of drives and enclosures supporting a storage system increases. For example, in current implementations, a unique command may need to be sent to each data storage device for each namespace reservation.

Therefore, there is a demand for a more efficient, reliable, and secure method for managing namespace reservations in multi-host storage systems, particularly in terms of storage enclosures and storage interface adapters in systems supporting a large number of hosts and namespaces.

### SUMMARY

Various aspects for reservation management using storage interface controllers, such as the storage interface adapters in the enclosure of an NVMeoF system, for multi-host namespaces in storage systems are described. More particularly, storage interface controllers may maintain a reservation datastore indicating which host systems have reservations for each namespace and include automated logic for updating and evaluating host identifiers for those reservations prior to allowing data access to the target namespace and data storage device that hosts it.

One general aspect includes a storage system that includes a first storage interface controller that includes: a host interface configured to receive host storage commands from a plurality of host systems; a storage device interface configured to direct host storage commands to at least one namespace in at least one data storage device; at least one memory; and at least one processor. The at least one processor is configured to, alone or in combination: receive, for a target namespace of the at least one namespace, a first connection request from a first host system from the plurality of host systems; determine, from the connection request, a first host identifier for the first host system; determine, for the target namespace, a reservation status and a reservation host identifier; selectively forward, responsive to the first host identifier matching the reservation host identifier, a storage request from the first host system to a data storage device of the at least one data storage device, where the data storage device is configured to host the target namespace; and selectively respond, responsive to the first host identifier not matching the reservation host identifier, to the storage request from the first host system with a reservation error message.

Implementations may include one or more of the following features. The storage system may include a reservation datastore that includes at least one reservation entry for the at least one namespace, where: each reservation entry of the at least one reservation entry may include a namespace identifier and a reservation key and a reservation host identifier for that namespace identifier. The at least one processor may be further configured to, alone or in combination, determine the reservation host identifier for the target namespace based on: determining a target namespace identifier from the first connection request; and reading, from a reservation entry including the target namespace identifier, the reservation host identifier for the target namespace. Each reservation entry of the at least one reservation entry may further include a reservation type for that namespace identifier. The reservation type may be selected from: exclusive write access, exclusive read/write access, shared write access, and shared read/write access. The storage system may include a second storage interface controller, where the at least one processor is further configured to synchronize a first copy of the reservation datastore in the first storage interface controller with a second copy of the reservation datastore in the second storage interface controller. The at least one processor may be further configured to, alone or in combination: query the data storage device hosting the target namespace for the reservation status and the reservation host identifier for the target namespace; and receive, from the data storage device hosting the target namespace, the reservation status and the reservation host identifier for the target namespace. The at least one processor may be further configured to, alone or in combination: initialize the data storage device hosting the target namespace; receive, responsive to initializing the data storage device hosting the target namespace, the reservation status and the reservation host identifier for the target namespace; and store, in a reservation datastore in the first storage interface controller, the reservation status and the reservation host identifier. The at least one data storage device may include a plurality of data storage devices, the at least one namespace may include a plurality of namespaces, and the at least one processor may be further configured to, alone or in combination: receive, for the plurality of data storage devices and the plurality of namespaces, a reservation configuration; generate, based on the reservation configuration, at least one reservation configuration command for the plurality of namespaces; and send, to each data storage device of the plurality of data storage devices, the at least one reservation configuration command. The at least one processor may be further configured to, alone or in combination: determine a source data storage device from the plurality of data storage devices; and query, prior to receiving the reservation configuration, the source data storage device for the reservation configuration. The at least one processor may be further configured to, alone or in combination, receive, from a host system of the plurality of host systems and prior to receiving the reservation configuration, a host configuration command may include at least one set of parameters selected from a source data storage device identifier and the reservation configuration. The storage system may include a data storage device enclosure that includes the at least one data storage device, where at least one data storage device includes a plurality of data storage devices; the first storage interface controller, where the first storage interface controller is configured as a first interface adapter circuit; and a second storage interface controller configured as a second interface adapter circuit.

Another general aspect includes a computer-implemented method that includes: receiving, by a first storage interface controller and for a target namespace, a first connection request from a first host system from a plurality of host systems configured for communication with a plurality of data storage devices through the first storage interface controller; determining, by the first storage interface controller and from the connection request, a first host identifier for the first host system; determining, by the first storage interface controller and for the target namespace, a reservation status and a reservation host identifier; selectively forwarding, by the first storage interface controller and responsive to the first host identifier matching the reservation host identifier, a storage request from the first host system to a data storage device of the plurality of data storage devices, where the data storage device hosts the target namespace; and selectively responding, by the first storage interface controller and responsive to the first host identifier not matching the reservation host identifier, to the storage request from the first host system with a reservation error message.

Implementations may include one or more of the following features. The computer-implemented method may include: storing, by the first storage interface controller and in a reservation datastore in the first storage interface controller, a plurality of reservation entries for a plurality of namespaces, where each reservation entry of the plurality of reservation entries includes a namespace identifier and a reservation key and a reservation host identifier for that namespace identifier, and the plurality of namespaces includes the target namespace; determining, by the first storage interface controller, a target namespace identifier from the first connection request; and reading, by the first storage interface controller and from a reservation entry including the target namespace identifier in the plurality of reservation entries, the reservation host identifier for the target namespace. The computer-implemented method may include reading, by the first storage interface controller and from the reservation entry, a reservation type for the target namespace, where: each reservation entry of the plurality of reservation entries further includes a reservation type for that namespace identifier, and the reservation type is selected from exclusive write access; exclusive read/write access; shared write access; and shared read/write access. The computer-implemented method may include synchronizing, by the first storage interface controller, a first copy of the reservation datastore in the first storage interface controller with a second copy of the reservation datastore in a second storage interface controller. The computer-implemented method may include: querying, by the first storage interface controller, the data storage device hosting the target namespace for the reservation status and the reservation host identifier for the target namespace; and receiving, by the first storage interface controller and from the data storage device hosting the target namespace, the reservation status and the reservation host identifier for the target namespace. The computer-implemented method may include: initializing, by the first storage interface controller, the data storage device hosting the target namespace; receiving, by the first storage interface controller and responsive to initializing the data storage device hosting the target namespace, the reservation status and the reservation host identifier for the target namespace; and storing, by the first storage interface controller and in a reservation datastore in the first storage interface controller, the reservation status and the reservation host identifier. The computer-implemented method may include: receiving, by the first storage interface controller and for the plurality of data storage devices and a plurality of namespaces, a reservation configuration; generating, by the first storage interface controller and based on the reservation configuration, at least one reservation configuration command for the plurality of namespaces; and sending, by the first storage interface controller and to each data storage device of the plurality of data storage devices, the at least one reservation configuration command. The computer-implemented method may include: determining, by the first storage interface controller, a source data storage device from the plurality of data storage devices; and querying, by the first storage interface controller and prior to receiving the reservation configuration, the source data storage device for the reservation configuration. The computer-implemented method may include receiving, by the first storage interface controller and from a host system of the plurality of host systems, prior to receiving the reservation configuration, a host configuration command may include at least one set of parameters selected from a source data storage device identifier and the reservation configuration.

Still another general aspect includes a storage system that includes: at least one processor; at least one memory; a plurality of data storage devices; a host interface configured to receive host storage commands from a plurality of host systems; a storage device interface configured to direct host storage commands to at least one namespace in the plurality of data storage devices; means for receiving, for a target namespace of the at least one namespace, a first connection request from a first host system from the plurality of host systems; means for determining, from the connection request, a first host identifier for the first host system; means for determining, for the target namespace, a reservation status and a reservation host identifier; means for selectively forwarding, responsive to the first host identifier matching the reservation host identifier, a storage request from the first host system to a data storage device of the plurality of data storage devices, where the data storage device is configured to host the target namespace; and means for selectively responding, responsive to the first host identifier not matching the reservation host identifier, to the storage request from the first host system with a reservation error message.

The various embodiments advantageously apply the teachings of data storage devices and/or multi-device storage systems to improve the functionality of such computer systems. The various embodiments include operations to overcome or at least reduce the issues previously encountered in storage arrays and/or systems and, accordingly, are more reliable, efficient, and/or secure than other computing systems. That is, the various embodiments disclosed herein include hardware and/or software with functionality to improve shared access to non-volatile memory resources by host systems in multi-tenant storage systems, such as by using automated host identifier evaluation to enforce reservations at the storage interface controller to control namespace and data storage device access. Accordingly, the embodiments disclosed herein provide various improvements to storage networks and/or storage systems.

It should be understood that language used in the present disclosure has been principally selected for readability and instructional purposes, and not to limit the scope of the subject matter disclosed herein.

### BRIEF DESCRIPTION OF THE DRAWINGS

FIG. 1 schematically illustrates a multi-device storage system supporting a plurality of host systems.

FIG. 2a schematically illustrates an example storage system for managing reservations for multiple host systems across enclosure migrations.

FIG. 2b is a flowchart of an example method of using the example storage system of FIG. 2a to manage host system access for enforcing reservations across enclosures.

FIG. 3 schematically illustrates aa example enclosure and storage interface adapter for the multi-device storage system of FIG. 1.

FIG. 4 schematically illustrates a host node of the multi-device storage system of FIG. 1.

FIG. 5 schematically illustrates some elements of the storage controller of FIGS. 1-3 in more detail.

FIG. 6a is a flowchart of a first example method of synchronizing reservation configurations across data storage devices.

FIG. 6b is a flowchart of a second example method of synchronizing reservation configurations across data storage devices.

FIG. 7 is a flowchart of an example method of enforcing reservation access at the storage interface controller.

FIG. 8 is a flowchart of an example method of establishing and updating a reservation datastore for the storage interface controller.

FIG. 9 is a flowchart of an example method of configuring multiple data storage devices through the storage interface controller.

### DETAILED DESCRIPTION

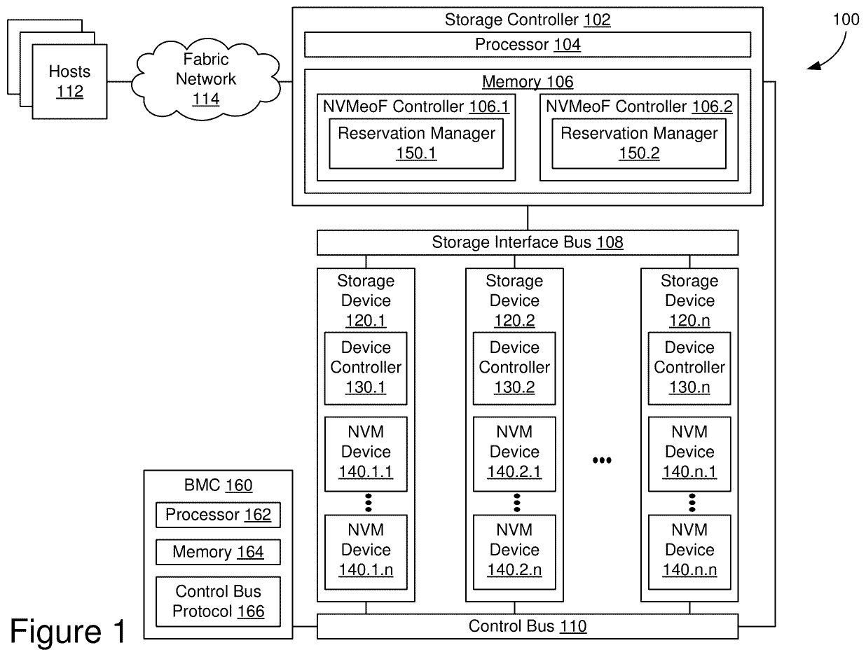

FIG. 1 shows an embodiment of an example data storage system 100 with multiple data storage devices 120 supporting a plurality of host systems 112 through storage controller 102. While some example features are illustrated, various other features have not been illustrated for the sake of brevity and so as not to obscure pertinent aspects of the example embodiments disclosed herein. To that end, as a non-limiting example, data storage system 100 may include one or more data storage devices 120 (also sometimes called information storage devices, storage devices, disk drives, or drives) configured in a storage node with storage controller 102. In some configurations, storage controller 102 may be embodied in one or more storage interface adapters or controllers and associated switches in a storage enclosure with associated data storage devices 120. In some embodiments, storage devices 120 may be configured in a server, storage array blade, all flash array appliance, just-a-bunch-of-flash (JBOF) enclosure, or similar storage unit for use in data center storage racks or chassis. Storage devices 120 may interface with one or more host nodes or host systems 112 and provide data storage and retrieval capabilities for or through those host systems. In some embodiments, storage devices 120 may be configured in a storage hierarchy that includes storage nodes, storage controllers (such as storage controller 102), and/or other intermediate components between storage devices 120 and host systems 112. For example, each storage controller 102 may be responsible for a corresponding set of storage devices 120 in a storage node and their respective storage devices may be connected through a corresponding backplane network or internal bus architecture including storage interface bus 108 and/or control bus 110, though only one instance of storage controller 102 and corresponding storage node components are shown. In some embodiments, storage controller 102 may include or be configured within a host bus adapter for connecting storage devices 120 to fabric network 114 for communication with host systems 112.

In the embodiment shown, a number of storage devices 120 are attached to a common storage interface bus 108 for host communication through storage controller 102. For example, storage devices 120 may include a number of drives arranged in a storage array, such as storage devices sharing a common rack, unit, or blade in a data center or the SSDs in an all flash array. In some embodiments, storage devices 120 may share a backplane network, network switch(es), and/or other hardware and software components accessed through storage interface bus 108 and/or control bus 110. For example, storage devices 120 may connect to storage interface bus 108 and/or control bus 110 through a plurality of physical port connections that define physical, transport, and other logical channels for establishing communication with the different components and subcomponents for establishing a communication channel to host 112. In some embodiments, storage interface bus 108 may provide the primary host interface for storage device management and host data transfer, and control bus 110 may include limited connectivity to the host for low-level control functions.

In some embodiments, storage devices 120 may be referred to as a peer group or peer storage devices because they are interconnected through storage interface bus 108 and/or control bus 110. In some embodiments, storage devices 120 may be configured for peer communication among storage devices 120 through storage interface bus 108, with or without the assistance of storage controller 102 and/or host systems 112. For example, storage devices 120 may be configured for direct memory access using one or more protocols, such as non-volatile memory express (NVMe), remote direct memory access (RDMA), NVMe over fabric (NVMeOF), etc., to provide command messaging and data transfer between storage devices using the high-bandwidth storage interface and storage interface bus 108.

In some embodiments, data storage devices 120 are, or include, solid-state drives (SSDs). Each data storage device 120.1-120.n may include a non-volatile memory (NVM) or device controller 130 based on compute resources (processors and memory) and a plurality of NVM or media devices 140 to provide a non-volatile storage medium for data storage (e.g., one or more NVM device(s), such as one or more flash memory devices). In some embodiments, a respective data storage device 120 of the one or more data storage devices includes one or more NVM controllers, such as flash controllers or channel controllers (e.g., for storage devices having NVM devices in multiple memory channels). In some embodiments, data storage devices 120 may each be packaged in a housing, such as a multi-part sealed housing with a defined form factor and ports and/or connectors for interconnecting with storage interface bus 108 and/or control bus 110. Each data storage device may include or have associated with it a unique data storage device identifier (device ID) used by storage controller 102 and/or other system components to manage or interface with individual data storage devices.

In some embodiments, a respective data storage device 120 may include a single medium device while in other embodiments the respective data storage device 120 includes a plurality of media devices. In some embodiments, media devices include NAND-type flash memory or NOR-type flash memory. In some embodiments, data storage device 120 may include one or more hard disk drives (HDDs). In some embodiments, data storage devices 120 may include a flash memory device, which in turn includes one or more flash memory die, one or more flash memory packages, one or more flash memory channels or the like. However, in some embodiments, one or more of the data storage devices 120 may have other types of non-volatile data storage media (e.g., phase-change random access memory (PCRAM), resistive random access memory (ReRAM), spin-transfer torque random access memory (STT-RAM), magneto-resistive random access memory (MRAM), etc.).

In some embodiments, each storage device 120 includes a device controller 130, which includes one or more processing units (also sometimes called central processing units (CPUs), processors, microprocessors, or microcontrollers) configured to execute instructions in one or more programs. In some embodiments, the one or more processors are shared by one or more components within, and in some cases, beyond the function of the device controllers. In some embodiments, device controllers 130 may include firmware for controlling data written to and read from media devices 140, one or more storage (or host) interface protocols for communication with other components, as well as various internal functions, such as garbage collection, wear leveling, media scans, and other memory and data maintenance. For example, device controllers 130 may include firmware for running the NVM layer of an NVMe storage protocol alongside media device interface and management functions specific to the storage device. Media devices 140 are coupled to device controllers 130 through connections that typically convey commands in addition to data, and optionally convey metadata, error correction information and/or other information in addition to data values to be stored in media devices and data values read from media devices 140. Media devices 140 may include any number (i.e., one or more) of memory devices including, without limitation, non-volatile semiconductor memory devices, such as flash memory device(s).

In some embodiments, media devices 140 in storage devices 120 are divided into a number of addressable and individually selectable blocks, sometimes called erase blocks. In some embodiments, individually selectable blocks are the minimum size erasable units in a flash memory device. In other words, each block contains the minimum number of memory cells that can be erased simultaneously (i.e., in a single erase operation). Each block is usually further divided into a plurality of pages and/or word lines, where each page or word line is typically an instance of the smallest individually accessible (readable) portion in a block. In some embodiments (e.g., using some types of flash memory), the smallest individually accessible unit of a data set, however, is a sector or codeword, which is a subunit of a page. That is, a block includes a plurality of pages, each page contains a plurality of sectors or codewords, and each sector or codeword is the minimum unit of data for reading data from the flash memory device.

A data unit may describe any size allocation of data, such as host block, data object, sector, page, multi-plane page, erase/programming block, media device/package, etc. In some configurations, the data unit may be the value portion of a key-value pair, where hosts 112 may define a key and provide a corresponding data unit of unstructured data (from a storage device perspective) having a memory size selected by the host. Storage devices 120 may store the key as a unique index value and map storage locations meeting the memory size in NVM devices 140 for storing the data unit. Storage locations may include physical and/or logical locations on storage devices 120 and may be described and/or allocated at different levels of granularity depending on the storage medium, storage device/system configuration, and/or context. For example, the storage device may manage the variable sizes of key-value pairs by allocating appropriately sized storage locations mapped to the particular key for addressability for host read/write purposes but managed as pages within storage device addressing managed in the media flash translation layer (FTL) in other contexts. Media segments may include physical storage locations on storage devices 120, which may also correspond to one or more logical storage locations. In some embodiments, media segments may include a continuous series of physical storage location, such as adjacent data units on a storage medium, and, for flash memory devices, may correspond to one or more media erase or programming blocks.

In some embodiments, storage controller 102 may be coupled to data storage devices 120 through a network interface that is part of host fabric network 114 and includes storage interface bus 108 as a host fabric interface. In some embodiments, host systems 112 are coupled to data storage system 100 through fabric network 114 and storage controller 102 may include a storage network interface, host bus adapter, or other interface capable of supporting communications with multiple host systems 112. Fabric network 114 may include a wired and/or wireless network (e.g., public and/or private computer networks in any number and/or configuration) which may be coupled in a suitable way for transferring data. For example, the fabric network may include any means of a conventional data communication network such as a local area network (LAN), a wide area network (WAN), a telephone network, such as the public switched telephone network (PSTN), an intranet, the internet, or any other suitable communication network or combination of communication networks. From the perspective of storage devices 120, storage interface bus 108 may be referred to as a host interface bus and provides a host data path between storage devices 120 and host systems 112, through storage controller 102 and/or an alternative interface to fabric network 114.

Host systems 112, or a respective host in a system having multiple hosts, may be any suitable computer device, such as a computer, a computer server, a laptop computer, a tablet device, a netbook, an internet kiosk, a personal digital assistant, a mobile phone, a smart phone, a gaming device, or any other computing device. Host systems 112 are sometimes called a host, client, or client system. In some embodiments, host systems 112 are server systems, such as a server system in a data center. In some embodiments, the one or more host systems 112 are one or more host devices distinct from a storage node housing the plurality of storage devices 120 and/or storage controller 102. In some embodiments, host systems 112 may include a plurality of host systems owned, operated, and/or hosting applications belonging to a plurality of entities and supporting one or more quality of service (QOS) standards for those entities and their applications. Host systems 112 may be configured to store and access data in the plurality of storage devices 120 in a multi-tenant configuration with shared storage resource pools, such as host connections to namespaces defined in storage devices 120.

Storage controller 102 may include one or more central processing units (CPUs) or processors 104 for executing compute operations, storage management operations, and/or instructions for accessing storage devices 120 through storage interface bus 108. In some embodiments, processors 104 may include a plurality of processor cores which may be assigned or allocated to parallel processing tasks and/or processing threads for different storage operations and/or host storage connections and operate alone or in combination. In some embodiments, processor 104 may be configured to execute fabric interface for communications through fabric network 114 and/or storage interface protocols for communication through storage interface bus 108 and/or control bus 110. In some embodiments, a separate network interface unit and/or storage interface unit (not shown) may provide the network interface protocol and/or storage interface protocol and related processor and memory resources.

Storage controller 102 may include a memory 106 configured to support a storage interface controller, such as NVMeoF controllers 106.1 and 106.2 that control communication between hosts 112 and storage devices 120 in accordance with a corresponding storage interface protocol. For example, NVMeoF controller 106.1 may support a plurality of namespaces allocated in storage devices 120 and manage access from hosts 112 through host connections to command queues allocated in storage devices 120. In some embodiments, memory 106 may include one or more dynamic random access memory (DRAM) devices for use by storage devices 120 for command, management parameter, and/or host data storage and transfer to support namespaces 150. In some embodiments, storage devices 120 may be configured for direct memory access (DMA), such as using remote direct memory access (RDMA) protocols, over storage interface bus 108.

In some configurations, NVMeoF controllers 106.1 and 106.2 may provide redundant interfaces for hosts 112 to access the shared storage resources of storage devices 120. For example, NVMeoF controllers 106.1 and 106.2 may be embodied in separate storage interface adapter circuits or cards that provide redundant network interfaces and one or more backend switches for connection to storage devices 120. In some configurations, multiple hosts from hosts 112 may have connections to the same namespace in one or more of storage devices 120. These hosts may share keys, objects, or blocks and support common applications supported by a shared namespace, enabling multiple hosts to issue store, retrieve, delete, and other host storage commands targeting the data in the namespaces. NVMeoF controllers 106.1 and 106.2 may support reservation management functions, including persisting host identifier and reservation key data from host reservations and host identifier verification for access control, for namespaces accessible by multiple hosts. For example, NVMeoF controllers 106.1 and 106.2 may include respective reservation managers 150.1 and 150.2 to support reservation configuration, maintenance, and verification at the storage interface controller for improved administration and security of the namespaces and data storage devices. The functions of reservation managers 150.1 and 150.2 may be further described below with regard to various features and implementations.

In some embodiments, data storage system 100 may include a baseboard management controller (BMC) 160. BMC 160 may include a specialized service processor that monitors the physical state of a computer, network server or other hardware device using sensors and communicating with the system administrator through an independent connection. In data storage system 100, BMC 160 may provide valuable information about the status and health of data storage devices 120, including temperature, drive status, and other physical conditions that could affect the performance or availability of the storage. BMC 160 may include a processor 162 and a memory 164 that operate independently of the host system's CPU, firmware, and operating system, such as storage controller 102, allowing it to function even when the storage system is powered down or otherwise nonfunctional. Note that these processors and memories may comprise multiple processors and memories configured to operation alone or in combination as described for other system components herein. In addition to its functions for remote management and monitoring of storage systems from an administrative system, BMC 160 may support an additional communication channel through control bus 110 to storage devices 120 and other subcomponents of data storage system 100, including NVMeoF controllers 106.1 and 106.2. For example, BMC 160 and control bus 110 may support low bandwidth communication protocols, such as Inter-Integrated Circuit (I2C), Serial Peripheral Interface (SPI), Improved Inter-Integrated Circuit (I3C), System Management Bus (SMBus), Universal Asynchronous Receiver/Transmitter (UART), or similar control bus protocols. For example, I2C is a synchronous, multi-master, multi-slave, packet-switched, single-ended, serial communication bus and corresponding protocol that may allow NVMeoF controllers 106.1 and 106.2 to communicate directly to share reservation configurations and data and/or use communication with BMC 160 and memory 164 as an intermediary for data synchronization.

In some embodiments, data storage system 100 includes one or more processors, one or more types of memory, a display and/or other user interface components such as a keyboard, a touch screen display, a mouse, a track-pad, and/or any number of supplemental devices to add functionality. In some embodiments, data storage system 100 does not have a display and other user interface components.

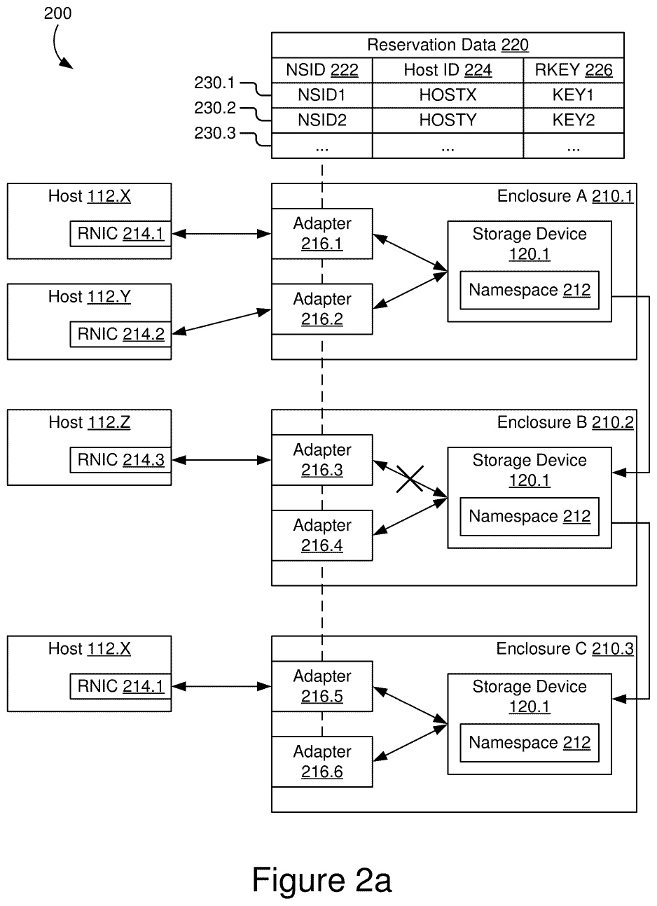

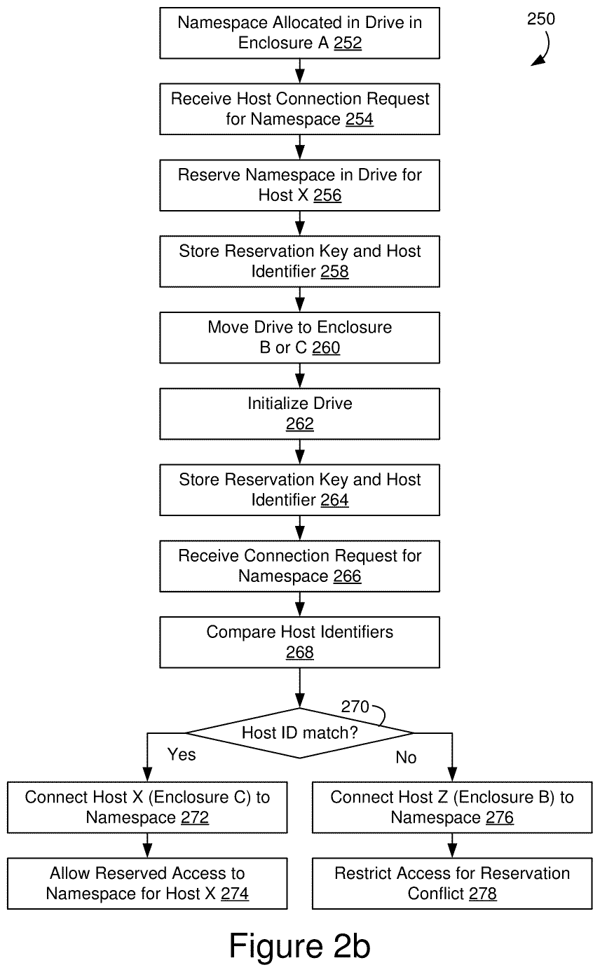

FIG. 2a illustrates a storage system 200 including multiple hosts and storage enclosures where storage device 120.1 is migrated between the different data storage device enclosures. The system may comprise multiple hosts 112.X, 112.Y, and 112.Z, network interfaces 214.1, 214.2, and 214.3, enclosures 210.1, 210.2, and 210.3, adapters 216.1-216.6, and a reservation data table 220. This system architecture may enable efficient management of storage resources and secure access control for multiple hosts in a shared storage environment using reservations.

Hosts 112.X, 112.Y, and 112.Z may serve as entry points for storage operations in the system. Each host may connect to a corresponding network interface 214.1, 214.2, and 214.3, which may facilitate communication between the hosts and the storage components. In some configurations, network interfaces 214 may be embodied in respective RDMA network interface controllers (RNICs). The RNICs may implement RDMA protocols for high-speed, low-latency data transfer. Different hosts may be connected to different enclosures 210 and namespaces, such as namespace 212 in storage device 120, at different times.

Enclosures 210.1, 210.2, and 210.3 may house the storage devices and adapters. For example, each enclosure may correspond to one or more rack enclosures that provide a chassis for housing various boards and/or devices and their respective wiring and interconnects. Each enclosure may contain two adapters, such as storage interface adapters, providing redundancy and load balancing capabilities between corresponding network ports and NVMe switches for connecting to multiple storage devices 120 (though only storage device 120.1 is shown). The adapters 216.1-216.6 may act as interfaces between the hosts and the storage devices and provide offloading of transport interface functions from a network protocol supporting NVMeoF storage communication to NVMe communication over peripheral component interconnect express (PCIe) or similar peripheral interface protocols. For example, they may act as an NVMeoF target for hosts 112 and an NVMe initiator for storage device 120.1. They may handle incoming requests from the hosts and route data and commands between the hosts and the storage devices.

Reservation data table 220 or a similar reservation datastore may store information about namespace reservations and persist that information at the storage interface adapter level. For example, an instance of reservation data table 220 may be maintained by each adapter 216.1-216.6. It may include columns for namespace identifiers 222, host identifiers 224, and reservation keys 226. Reservation data table 220 may contain multiple data entries 230.1, 230.2, and 230.3, each representing a specific reservation for a namespace and the corresponding host identifier and reservation key. This table may be used by adapters 216.1-216.6 to manage and enforce access control for the namespaces.

In the example shown, during a first operating period, storage device 120.1 may be installed in enclosure 210.1 and hosts namespace 212. Host X and host Y may both have connections through host adapters 216.1 and 216.2 to namespace 212, which has a corresponding namespace identifier of NSID1. Both hosts may be registrants of namespace 212. Host X may have a reservation for namespace 212 that includes a reservation type, such as exclusive write access and reservation data for that reservation has been persisted in reservation data entry 230.1 in reservation data table 220.

During a second operating period, storage device 120.1 may be migrated to enclosure B 210.2. Host Z may be connected to enclosure B 210.2 through at least adapter 216.3. Host Z may attempt write access to namespace 212 in violation of the reservation established by host X. However, adapter 216.3 may be configured to persist reservation data table 220 and use the host identifier stored for the reservation to verify whether or not host Z has the requisite permissions. For example, in response to a connection request from host Z for namespace 212, adapter 216.3 may determine host Z's host identifier from the connection request and compare it to reservation entry 230.1 for NSID1. Because the host identifier values do not match, adapter 216.3 may acknowledge the connection to namespace 212 while providing a reservation violation notification back to host Z and preventing storage commands in violation of the reservation from reaching storage device 120.1. Note that host Z may still be acknowledged if it is a registrant of namespace 212 (assuming it is), but adapter 216.3 may be configured to enforce the reservation of host X that has persisted despite storage device 120.1 moving between enclosures.

During a third operating period, storage device 120.1 may be migrated to enclosure C 210.3. Host X may send a connection request to adapter 216.5 in enclosure C 210.3. Adapter 216.5 may be similarly configured to persist reservation data table 220 and use data entry 230.1 to verify the access rights of host X under the reservation. In this case, the host identifier received in the connection request from host X would match the host identifier stored in data entry 230.1 and host X would be granted write access privileges in accordance with reservation KEY1 and the reservation type. Because host X is the reservation holder and that has been verified by adapter 216.5, host X may interact with namespace 212 in accordance with the reservation established while storage device 120.1 was in enclosure A 210.1, even though it was two migrations ago.

FIG. 2b illustrates a flowchart of a method 250 for managing namespace reservation and access in a storage system, such as storage system 200. The method may be executed by the storage interface adapters, such as adapters 216.1-216.6, in conjunction with the storage devices 120.1 and hosts 112.X, 112. Y, and 112.Z. The method may result in secure and controlled access to namespaces as drives are moved between different enclosures. This method may enable the storage system to maintain reservation integrity and enforce access controls even when storage devices are relocated within the system.

At block 252, a namespace may be allocated in a drive in enclosure A. For example, one of the hosts or a system administrator may create a new namespace 212 on storage device 120.1.

At block 254, a host connection request for the namespace may be received. For example, host 112.X may send a connection request to adapter 216.1 to access the newly created namespace 212.

At block 256, the namespace in the drive may be reserved for host X. For example, the connection request from host 112.X may be followed by a reservation request and configure a reservation of namespace 212 in data storage device 120.1 for host X.

At block 258, the reservation key and host identifier may be stored. For example, adapter 216.1 may update reservation data table 220 with reservation data from the reservation request and/or the resulting feature record in storage device 120.1, such as the reservation key and host identifier for host 112.X.

At block 260, the drive may be moved to enclosure B or C. For example, storage device 120.1 containing namespace 212 may be physically relocated from a slot in enclosure A 210.1 to a slot in enclosure B 210.2 or enclosure C 210.3.

At block 262, the drive may be initialized. For example, when storage device 120.1 is connected to enclosure 210.2, adapter 216.3 may detect and initialize the newly connected drive.

At block 264, the reservation key and host identifier may be stored. For example, adapter 216.3 may read the reservation information from storage device 120.1 and update its local reservation data table 220.

At block 266, a connection request for the namespace may be received. For example, host 112. Y may send a connection request to adapter 216.3 or host 112.X may send a connection request to adapter 216.5 to access namespace 212 on the relocated storage device 120.1.

At block 268, the host identifiers may be compared. For example, adapter 216.3 or adapter 216.5 may compare the host identifier from the connection request with the stored host identifier in its reservation data table 220.

At block 270, a determination may be made as to whether or not the host identifiers match. For example, adapter 216.3 or adapter 216.5 may evaluate the comparison at block 268. If the host IDs from the request and the table match, method 250 may proceed to block 272. If the host IDs for the request and the table do not match, method 205 may proceed to block 276.

At block 272, a host connection to the namespace may be allowed from the host, such as for Host X in enclosure C. For example, the host connection request may allow the host to connect to the namespace in compliance with NVMe host connection protocols.

At block 274, reserved access to the namespace may be allowed. For example, if the connection request is from host 112.X, adapter 216.5 in enclosure C 210.3 may grant access to namespace 212 in accordance with the existing reservation-granting host X the reserved access privileges defined for the reservation type and based on the storage operations submitted through the host connection.

At block 276, a host connection to the namespace may be allowed from the host, such as for Host Z in enclosure B. For example, the host connection request may allow the host to connect to the namespace in compliance with NVMe host connection protocols.

At block 278, access may be restricted for reservation conflict. For example, if the connection request is from host 112.Z, adapter 216.3 in enclosure B 210.2 may deny read and/or write access to namespace 212 in accordance with the reservation type due to the existing reservation for host 112.X-enhancing data security.

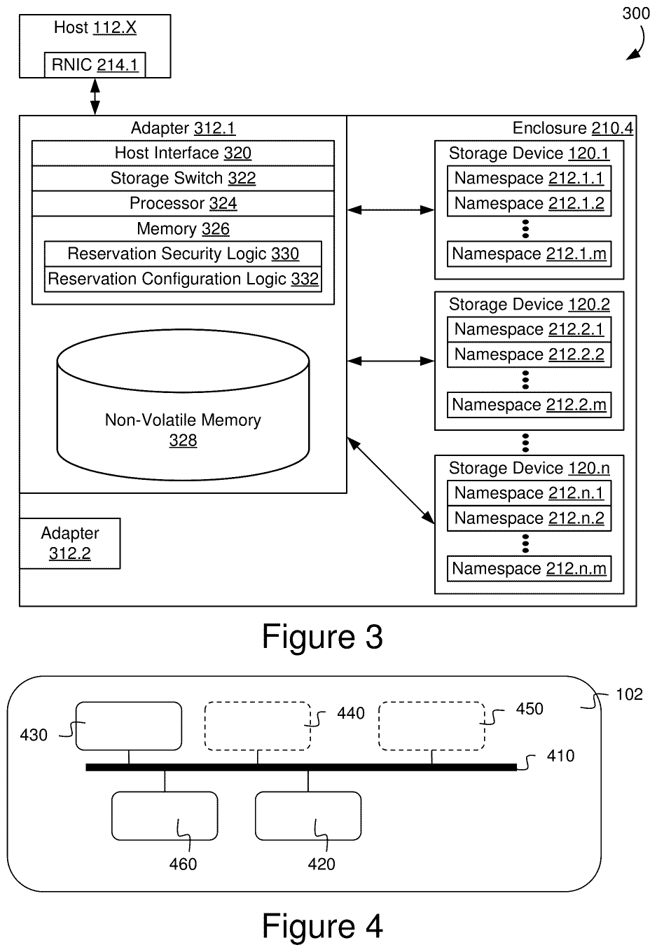

FIG. 3 illustrates a block diagram of a storage system architecture 300. The system may include a host 112.X, a network interface 214.1, adapters 312.1 and 312.2, and a storage enclosure 210.4 containing multiple storage devices 120.1-120.n with namespaces 212.1.1-212.n.m. This system architecture may enable efficient management of storage resources and secure access control for multiple hosts in a shared storage environment be locating reservation management features in adapters 312.1 and 312.2.

Host 112.X may be as described in FIG. 2a. It may serve as the entry point for storage operations in the system. Network interface 214.1 may also be as described in FIG. 2a, such as an RNIC facilitating communication between the host and adapters 312.1 and/or 312.2 through a network fabric.

Adapter 312.1 may act as an interface between the host and the storage devices, configured to receive host commands via a network interface and provide peripheral interface connections to storage devices 120.1-120.n. Adapter 312.2 may provide redundancy and load balancing capabilities and may mirror the functionality of adapter 312.1, though the subcomponents of adapter 312.2 have been omitted for brevity. Adapter 312.1 may include a host interface 320 that may handle incoming requests from the host. For example, host interface 320 may include a network interface and associated NVMeoF compliant messaging interface configured as an NVMeoF target for host communications. Adapter 312.1 may include or interface with a storage switch 322, such as a PCIe switch, to route data and commands between the host interface and the storage devices. This may allow adapter 312.1 to provide a unified target for host 112.X to reach all of the connected namespaces 212.1.1-212.n.m in storage devices 120.1-120.n. Adapter processor 324 and adapter memory 326 may work together to execute adapter operations and store temporary data. Adapter processor 324 and adapter memory 326 may be configured and operate substantially as described for processor 104 and memory 106 in FIG. 1.

Adapter 312.1 may be configured to include reservation management functions similar to reservation managers 150.1 and 150.2 in FIG. 1. More specifically, adapter 312.1 may include a reservation security logic 330 configured to manage the persistence of reservation data and access control features implemented at the adapter level and reservation configuration logic configured to manage the replication of reservation configuration setting across the population of storage devices 120.1-120.n. For example, reservation security logic 330 may implement instantiation and maintenance of a reservation data table or similar data structure and use reservation data entries from that table to verify host IDs each time a new connection request is received from a host. Non-volatile memory 328 may provide the persistent, non-transitory memory for storing the reservation data table and/or reservation configuration setting and maintaining them through power cycles and other system change events. In some configurations, reservation configuration logic 332 may manage reservation configuration settings across storage devices 120.1-120.n. For example, reservation configuration logic 332 may support an atomic host command for setting a reservation configuration across all of the storage devices, where reservation configuration logic 332 receives the host command, extracts its reservation configuration parameters, and replicates them in multiple commands to the set of storage devices. The functions of reservation security logic 330 and reservation configuration logic 332 may be further described below.

The storage enclosure 210.4 may house multiple storage devices 120.n. Each storage device may contain multiple namespaces 212.n.1 through 212.n.m. These namespaces may represent logical divisions of storage capacity that can be individually managed and assigned to different hosts. Enclosure 210.4 may be configured substantially as described above regarding enclosures 210.1-210.3.

FIG. 4 shows a schematic representation of an example host system 112. Host system 112 may comprise a bus 410, a processor 420, a local memory 430, one or more optional input units 440, one or more optional output units 450, and a communication interface 460. Bus 410 may include one or more conductors that permit communication among the components of host 112. Processor 420 may include one or more of any type of conventional processor or microprocessor that interprets and executes instructions, alone or in combination. Local memory 430 may include a random access memory (RAM) or another type of dynamic storage device that stores information and instructions for execution by processor 420 and/or a read only memory (ROM) or another type of static storage device that stores static information and instructions for use by processor 420 and/or any suitable storage element such as a hard disk or a solid state storage element. An optional input unit 440 may include one or more conventional mechanisms that permit an operator to input information to host 112 such as a keyboard, a mouse, a pen, voice recognition and/or biometric mechanisms, etc. Optional output unit 450 may include one or more conventional mechanisms that output information to the operator, such as a display, a printer, a speaker, etc. Communication interface 460 may include any transceiver-like mechanism that enables host 112 to communicate with other devices and/or systems, such as an RNIC or conventional Ethernet interface supporting transport control protocol (TCP) communication.

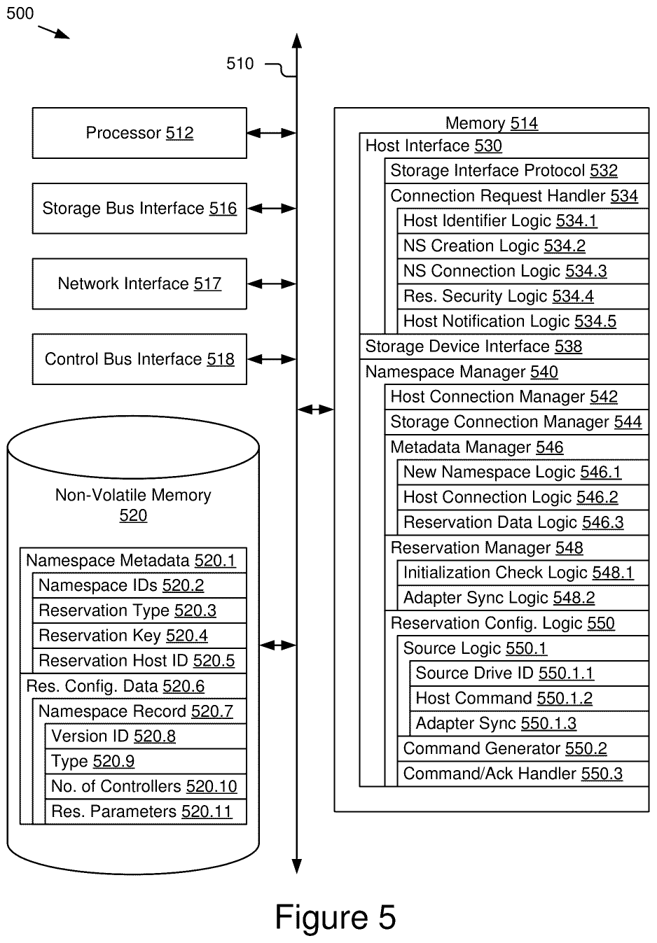

FIG. 5 schematically shows selected modules of a storage system 500 configured for managing reservations in the storage interface controller. Storage system 500 may incorporate elements and configurations similar to those shown in FIGS. 1-3. For example, storage system 500 may be configured as NVMeoF controller 106.1 or 106.2 in FIG. 1 and/or a storage interface adapters 216 in FIG. 2a or 316 in FIG. 3. In some embodiments, storage system 500 may be embodied in a hardware NVMeoF controller, such as a specialized adapter circuit device that manages the communication between hosts and storage devices in an NVMeoF network. The NVMeoF controller may be responsible for receiving storage commands from hosts, directing these commands to the appropriate namespaces in the storage devices, and managing the responses. As described below, one or more NVMeoF controllers may be configured to maintain reservation information and use it to manage host access to the namespaces in the connected data storage devices, as well as replicate reservation data and/or reservation configurations among various components.

Storage system 500 may include a bus 510 interconnecting at least one processor 512, at least one memory 514, and at least one interface, such as storage bus interface 516, network interface 517, and/or control bus interface 518. Bus 510 may include one or more conductors that permit communication among the components of storage system 500. Processor 512 may include any number and type of processors or microprocessors that interpret and execute instructions or operations, alone or in combination. Memory 514 may include a random access memory (RAM) or another type of dynamic storage device that stores information and instructions for execution by processor 512 and/or a read only memory (ROM) or another type of static storage device that stores static information and instructions for use by processor 512 and/or any suitable storage element such as a hard disk or a solid state storage element. In some configurations, non-volatile memory devices 520 may include storage controller memory devices supporting memory 514 and/or allocated for system use in one or more of the attached SSDs. For example, non-volatile memory 520 may include onboard memory of one or more NVMeoF controllers used to store namespace metadata 520.1 and/or reservation configuration data 520.6.

Storage bus interface 516 may include a physical interface for connecting to one or more data storage devices, such as a peripheral component interconnect connecting to a corresponding switch, using an interface protocol that supports storage device access. For example, storage bus interface 516 may include a network (e.g., ethernet), PCIe, or similar storage interface connector supporting NVMe access to solid state media comprising non-volatile memory devices. These connected data storage devices may include one or more non-volatile memory devices or similar storage elements configured to store host data organized in namespaces or similar logical data containers. For example, non-volatile memory devices may include a plurality of flash memory packages organized as an addressable memory array.

Network interface 517 may be used by storage system 500 to communicate with a number of host systems. Network interface 517, also known as a host interface, may be a hardware component or a software module that provides a communication channel between storage system 500 and the host systems. Network interface 517 may support various network protocols, such as Ethernet, Fibre Channel, or InfiniBand, to facilitate the communication between storage system 500 and the host systems. The choice of network protocol can depend on various factors, such as the network infrastructure, the performance requirements, and the compatibility with the host systems, the storage devices, and NVMeoF protocols.

Control bus interface 518 may be used by storage system 500 to communicate with other hardware systems or subsystems, such as a baseboard management controller, and provide a communication path among subsystem components, such as multiple NVMe-F controllers. Control bus interface 518 may include a physical interface for connecting to a control bus using a low-bandwidth interface protocol for low-level control messaging among computing components. For example. control bus interface 518 may include a I2C, I3C, SPI, SMBus, UART, or similar bus interface connector supporting component-to-component messaging, such as multi-master, packet-based messaging over a two-wire bus.

Storage system 500 may include a plurality of modules or subsystems that are stored and/or instantiated in memory 514 for execution by processor 512 as instructions or operations. For example, memory 514 may include a host interface 530 configured to receive, process, and respond to host connection and data requests from client or host systems. Memory 514 may include a storage device interface 538 configured to establish backend connections with data storage devices hosting namespaces and processing host storage commands. Memory 514 may include a namespace manager 540 configured to manage host connections to namespaces through storage system 500, including the management of reservations and reservation configurations for those data storage devices.

Host interface 530 may include an interface protocol and/or set of functions and parameters for receiving, parsing, responding to, and otherwise managing requests from host devices, nodes, or systems. For example, host interface 530 may include functions for receiving and processing host requests for establishing host connections with one or more namespaces for reading, writing, modifying, or otherwise manipulating client or host data in accordance with host communication and storage protocols. Host interface 530 may include logic for enforcing reservations at the adapter level. In some embodiments, host interface 530 may enable direct memory access and/or access over NVMe protocols, such as RDMA and transmission control protocol/internet protocol (TCP/IP) access, through storage bus interface 516 to host data units stored in the non-volatile memory devices of connected data storage devices. For example, host interface 530 may include host communication protocols compatible with ethernet and/or another host interface that supports use of NVMe and/or RDMA protocols for data access to host data.

In some embodiments, host interface 530 may include a plurality of hardware and/or software modules configured to use processor 512 and memory 514 to handle or manage defined operations of host interface 530. For example, host interface 530 may include a storage interface protocol 532 configured to comply with the physical, transport, and storage application protocols supported by the host for communication over network interface 517. For example, host interface 530 may include a connection request handler 534 configured to receive and respond to host connection requests. In some embodiments, host interface 530 may include additional modules (not shown) for command handling, buffer management, storage device management and reporting, and other host-side functions.

In some embodiments, storage interface protocol 532 may include network and/or PCIe and NVMe compliant communication, command, and syntax functions, procedures, and data structures. In some embodiments, storage interface protocol 532 may include an NVMeoF or similar protocol supporting RDMA, transmission control protocol/internet protocol (TCP/IP), and/or other connections for communication between host nodes and target host data in connected data storage devices, such as namespaces mapped to the particular host. Storage interface protocol 532 may include interface definitions for receiving host connection requests and storage commands from the fabric network, as well as for providing responses to those requests and commands. In some embodiments, storage interface protocol 532 may assure that host interface 530 is compliant with host request, command, and response syntax while storage device interface 538 may be configured to interface with the data storage devices for processing host storage commands. Storage interface protocol 532 may support host reservation requests for target namespaces to reserve specific storage functions to that namespace for one or more specified hosts.

In some embodiments, connection request handler 534 may include interfaces, functions, parameters, and/or data structures for receiving host connection requests in accordance with storage interface protocol 532, determining an available command queue, such as a queue-pair, allocating the host connection (and corresponding host connection identifier) to a storage device processing queue, and providing a response to the host, such as confirmation of the host storage connection or an error reporting that no processing queues are available. For example, connection request handler 534 may receive a storage connection request for a target namespace in a NVMeoF storage device and provide an appropriate namespace storage connection (through namespace manager 540) and host response. Connection request handler 534 may include host identifier logic 534.1 configured to use transport parameters from the host connection request to determine the host identifier of the request. Note that host identifiers may include host NVMe qualified names (NQNs) and are distinct from host connection identifiers, which identify a specific host connection to a namespace (and may support multiple connections from the same host to the same namespace). Namespace creation logic 534.2 may be initiated by connection request handler 534 in response to a host connection request for a namespace identifier that does not yet exist in the data storage devices. Namespace creation logic 543.2 may be configured to create a new namespace by allocating available storage space and a supported namespace from a data storage device to the new namespace identifier. For example, namespace creation logic 534.2 may initiate namespace manager 540 and storage device interface 538 to determine a target storage device and allocate the namespace in that storage device. Namespace connection logic 534.3 may be initiated by connection request handler 534 for an existing or newly created namespace to allocate a new host connection to that namespace for the requesting host. For example, namespace connection logic 534.3 may allocate a specific queue pair and host connection identifier to the combination of the host identifier and the namespace identifier. That connection may then be used for processing host storage commands to the namespace. In some embodiments, data describing each host connection request and/or resulting host connection may be stored by namespace manager 540.

In some configurations, connection request handler 534 may be configured to support reservation functions by providing an added layer of security for checking host privileges under one or more existing reservations. For example, reservation security logic 534.4 may be configured to verify the host identifier in the connection request prior to allocating queue pairs to the connection request that enable communication with the target storage device. Reservation security logic 534.4 may determine the host identifier from the request using host identifier logic 534.1 and then search namespace metadata 520.1 for corresponding reservation data. For example, namespace metadata 520.1 may include a reservation data table or similar data structure indexed by namespace identifiers 520.3 to enable reservation security logic 534.4 to locate any reservation data entries corresponding to the target namespace. The reservation data entries may include a reservation type 520.3, a reservation key 520.4, and a corresponding reservation host identifier 520.5 for the host that holds the reservation. Reservation security logic 534.4 may compare the host ID from the request to the host ID from the reservation datastore. If the identifier values match, the host connection request may be processed to establish the host connections and command queues to the target namespace on the hosting data storage device. If the identifier values do not match, the command queues may not be allocated and a reservation violation notification may be returned to the host system. Connection request handler 534 may include host notification logic 534.5 for generating response messages to host connection and storage commands and may include logic for generating reservation responses.

Storage device interface 538 may include an interface protocol and/or set of functions, parameters, and data structures for communicating with connected data storage devices to establish host connections and enable command queue pairs (submission queues and completion queues) for processing host storage commands. Storage device interface 538 may be configured with a storage interface protocol similar to storage interface protocol 532 but supporting the backend connection between storage system 500 and the set of data storage devices it supports. For example, storage device interface 538 may receive host storage commands received by host interface 530 and direct them through one or more switches to the target data storage devices for processing. In some configurations, storage device interface 538 may also support administrative communication (such as via administrative queues and commands) for managing storage device and namespace configuration and other backend functions. For example, administrative commands for configuring host reservations and/or determining feature parameters stored by the data storage devices may be handled through administrative command queues. In some configurations, one or more NVMeoF controllers and corresponding input/output modules of storage device interface 538 may be the only “hosts” connected to and visible from the storage devices and the storage devices may rely on storage device interface 538 for receiving all host storage commands and administrative commands.

Namespace manager 540 may include a set of functions, parameters, and data structures for managing namespaces and corresponding host connections in storage system 500. For example, namespace manager 540 may receive host connection requests and determine corresponding storage connections for each namespace, as well as managing namespace creation, deletion, reservation data, and reservation configurations across data storage devices. In some configurations, some or all functions of namespace manager 540 may be embodied in NVMeoF controller firmware operating as an intermediary between host interface 530 and storage device interface 538 and may use control bus protocol 560 for communication with other NVMeoF controllers in the same system. In some embodiments, namespace manager 540 may include a plurality of hardware and/or software modules configured to use processor 512 and memory 514 to handle or manage defined operations of namespace manager 540. For example, namespace manager 540 may include a host connection manager 542, a storage connection manager 544, a metadata manager 546, a reservation manager 548, and reservation configuration logic 550.

Host connection manager 542 and storage connection manager 544 may include interfaces, functions, parameters, and/or data structures configured to manage namespace allocations and connections between host systems and storage devices. For example, host connection manager 542 may include logic for receiving host connection requests and maintaining a list of host connection identifiers mapped to specific namespaces and queue pairs. Storage connection manager 544 may include logic for receiving the configurations of namespaces, command queues, and storage space available among storage devices and map new namespaces and host connections to the storage device resources. Host connection manager 542 and storage connection manager 544 may use metadata manager 546 and namespace metadata 520.1 to manage their respective front-end and back-end connections. Host connection manager 542 may be responsive to host interface 530 for processing host connection requests and delete requests, as well as managing host connection timeouts. Storage connection manager 544 may be responsive to storage device interface 538 and manage storage device namespace and queue pair allocations for completing host connections.

Metadata manager 546 may include interfaces, functions, parameters, and/or data structures configured to manage namespace and corresponding connection data to assist in managing namespaces. For example, metadata manager 546 may receive data generated or received by host interface 530, storage device interface 538, and/or other components of namespace manager 540 and store it in one or more data structures in namespace metadata 520.1. In some configurations, metadata manager 546 may create, configure, and maintain a namespace metadata table or similar data structure for tracking sets of host connections to each namespace. A portion of the namespace metadata table and/or a separate data table may be used for reservation data. For example, portions of the namespace metadata table may be configured similarly to reference data table 220 in FIG. 2a and include namespace IDs 520.2, reservation kyes 520.4, and host IDs 520.5. Metadata manager 546 may create a namespace entry indexed by namespace identifier as each new namespace is created, add reservation data as new reservations are made, and update and synchronize reservation data in response to various events.

In some embodiments, metadata manager 546 may include new namespace logic 546.1 configured to generate new namespace entries responsive to a new namespace being created. Metadata manager 546 may include host connection logic 546.2 configured to add host connections entries for host connections to various namespaces as they are created, as well as removing them in response to connection timeout events. Metadata manager 546 may include reservation data logic 546.3 configured to add reservation data for each reservation for a namespace managed by namespace manager 540. For example, each time a host or system administrator requests or defines a reservation, the corresponding reservation key 520.4 may be associated with the namespace identifier 520.2 and reservation host identifier 520.5 in namespace metadata 520.1. Metadata manager 546 may also store a reservation type for systems that support multiple types of reservations, such as exclusive write access, exclusive read/write access, shared write access, and shared read/write access. In this context, exclusive means reserved to a single host and shared means reserved to multiple (identified) hosts. In some configurations, reservation data stored by metadata manager 546 may also include reservation configuration data 520.6 that defines a set of reservation parameters for each namespace generally (independent of the configuration of actual reservations to specific hosts).

Reservation manager 548 may include logic for specifically managing and persisting reservation data for the namespaces. For example, reservation manager 548 may use one or more data sources to capture namespace reservations and their associated data in namespace metadata 520.1. More specifically, reservation manager 548 may include the logic that collects reservation data and passes it to metadata manager 546 to store that data. In some configurations, reservation manager 548 may include initialization check logic 546.1 configured to use the initialization sequence for a data storage device to capture the set of existing reservations for that data storage device. For example, storage system 500 may include an initialization sequence and series of commands sent to the storage device during initialization, such as identify, set feature, I/O queue create (for completion and submission queues), get feature, and asynchronous event requests. In some configurations, one or more get feature requests may be used to query the data storage device for reservation data. For example, a get command with a specified command parameter may be used to determine the host identifier associated with a particular namespace and reservation. In some configurations, a reservation report may be requested from the storage device to provide a structured report on the current reservations for the namespaces in the storage device. Reservation data may be extracted from the report for storage by metadata manager 546. In some configurations, reservation manager 548 may include adapter synchronization (sync) logic 548.2 for sharing reservation data among storage interface controllers. For example, once one storage interface controller in the system has determined the reservation data for the namespaces across one or more storage devices, that data may be synchronized across multiple adapters to avoid redundant queries to the drives. Within an enclosure with multiple storage interface controllers, reservation data may be shared directly across control bus interface 518. In some configurations, reservation data may be shared between storage interface controllers in the same enclosure or across multiple enclosures using a data path through network interface 517, with or without a host system as an intermediary.

Reservation configuration logic 552 may include logic for determining the reservation configurations used for the different namespaces defined or requested in each data storage device. For example, reservation configuration logic 552 may enable more efficient configuration of reservations by providing a common set of reservation parameters for each data storage device to use in defining reservations. In some configurations, a set of reservation configuration parameters may be defined and shared across data storage devices. For example, each data storage device may receive a reservation configuration that includes reservation type 520.9, number of controllers 520.10, and a series of reservation parameters 520.11 for each host identifier, such as a register control extension, control identifier, reservation status, and reservation key. The reservation type and controller configuration may be shared across all host reservations, but reservation parameters 520.11 may be specific to a reservation instance for a particular host and reservation key. In some configurations, one or more configuration records 520.7 may be defined or received and stored in non-volatile memory 520 for use in replication across the data storage devices. Version identifier 520.6 may be a serialized identifier that enables version control for the configuration setting to assure that the most recent version is being used and synchronized across multiple data storage devices and may be incremented each time the reservation configuration data changes.

In order to replicate the reservation configuration data across data storage devices, reservation configuration logic 552 may identify a source for the configuration data. Some embodiments may support one or more data sources through source logic 552.1. For example, source drive identifier 552.1.1 may designate a specific data storage device as the source drive for replicating the reservation configuration from that drive to other drives in the enclosure. A host system or administrator may configure the desired reservation configuration in the source drive using conventional reservation configuration commands, then source logic 552.1 may access the configuration data through a reservation status report and extract the reservation configuration parameters from the report to replicate them in configuration commands to the other data storage devices. In another configuration, a host command 552.1.2 may be a host configuration command that includes the reservation configuration parameters. For example, a conventional reservation configuration command used by host system for a target namespace may include an extension or parameter that indicates to the adapter that the reservation configuration parameters are intended for all data storage devices and namespaces, not just one device or namespace. The parameters I the command may then be stored and used for the generation of repeated commands to the various namespaces and/or storage devices. In still another configuration, adapter synchronization 552.1.3 may be used as the source for replication. For example, the adapter may be configured with reservation configuration parameters in reservation configuration data 520.6 and a command may be received to use that data as the source to replicate the reservation configuration parameters across the data storage devices and namespaces.

Command generator 552.2 may use the reservation configuration data from the source identified by source logic 552.2 to generate at least one configuration command per namespace or data storage device. For example, command generator 552.2 may include command syntax, such as a command template, and populate it with the reservation configuration data and relevant parameters for designating the target namespace or data storage device to be configured. In some configurations, command generator 552.2 may identify a set of data storage device or namespace identifiers including all of the devices or namespaces in storage system 500 and iteratively generate a command to each identifier based on the command syntax and reservation configuration data. Command and acknowledgement handler 552.3 may be configured to send each reservation configuration command to the target data storage device and await a responsive acknowledgement. For example, command and acknowledgement handler 552.3 may send the generated commands in sequence to the administrative submission queues for the target data storage devices and/or namespaces and use the corresponding completion queues to await a corresponding acknowledgement. As further described below, reservation configuration logic 552 may use the acknowledgements to manage whether all devices have been configured and handle additional attempts as needed. In some configurations, reservation configuration logic 552 may also include logic for ongoing identification of changes in the reservation configuration and initiate a similar process of updating all of the namespaces and devices for the identified change using an additional round of commands.

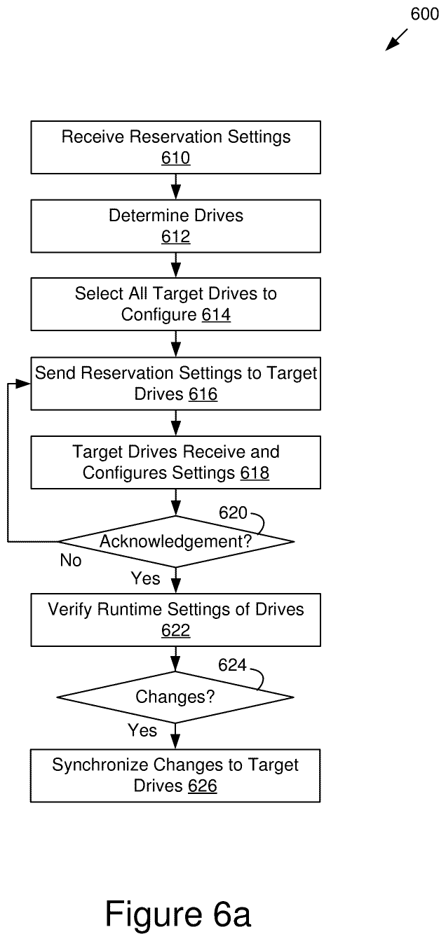

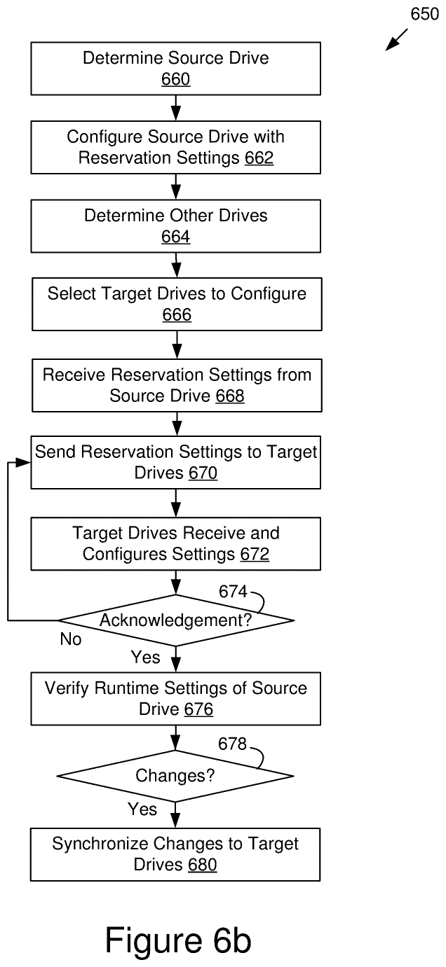

FIG. 6a illustrates a flowchart of a method 600 for configuring reservation settings across drives. The method may be executed by the storage interface adapters, such as adapters 216.1-216.6 or 312.1-312.2, in conjunction with storage devices 120. The method may result in consistent reservation settings across multiple storage devices in the system. This method may enable efficient and synchronized configuration of reservation settings, ensuring that all drives in the system maintain the same access control parameters while reducing host overhead.

At block 610, reservation settings may be received. For example, the storage interface adapter may receive reservation configuration parameters from a host system or an administrative interface.

At block 612, the drives to be configured may be determined. For example, the adapter may identify all the storage devices connected in the storage enclosure that require the new or updated reservation settings.

At block 614, the target drives may be selected for configuration. For example, the adapter may use the list of drives determined at block 612 to receive simultaneous reservation configuration commands.

At block 616, the reservation settings may be sent to the target drives. For example, the adapter may transmit the reservation configuration parameters to the selected storage devices using a simultaneous broadcast of the configuration command for each target drive to mirror the settings across the set of devices.

At block 618, the target drives may receive and configure their respective settings. For example, each storage device may apply the received reservation configuration settings to its namespaces and any future reservation requests by configuring and storing appropriate reservation configuration parameters, such as in a configuration register or page in memory.

At block 620, a determination may be made as to whether acknowledgments have been received. For example, the adapter may wait for confirmation messages from each storage device indicating successful application of the settings. If not all acknowledgements are received, method 600 may return to block 616 to resend the configuration command. If acknowledgement messages are received for all drives, method 600 may proceed to block 622.

At block 622, runtime settings of the drives may be verified. For example, the adapter may check the current configuration of each drive on a periodic basis, such as by requesting a reservation status report, to ensure no changes have occurred during the (or since the last) configuration process.

At block 624, a determination may be made as to whether there are any changes to the settings. For example, the adapter may compare the current settings of each drive with the originally received reservation settings. If no changes are present, method 600 may end the configuration or may return to block 622 periodically to check for runtime changes. If yes, method 600 may proceed to block 626.

At block 626, changes may be synchronized to the target drives. For example, if any discrepancies are found, the adapter may send updated settings to all configured drives using corresponding configuration commands to ensure consistency across the system.

FIG. 6b illustrates a flowchart of a method 650 for configuring and synchronizing reservation settings across drives using a source drive. The method may be executed by the storage interface adapters, such as adapters 216.1-216.6 or 312.1-312.2, in conjunction with the storage devices 120. The method may result in consistent and up-to-date reservation settings across multiple storage devices in the system. This method may enable efficient propagation of reservation configurations from a source drive to multiple target drives, ensuring system-wide consistency and adaptability to runtime changes.

At block 660, a source drive may be determined. For example, the adapter may designate or receive a host command designating a storage device as the source drive for reservation settings.

At block 662, the source drive may be configured with reservation settings. For example, the adapter or a host command may apply a set of reservation parameters to the designated source drive.

At block 664, other drives may be determined. For example, the adapter may identify all other storage devices in the storage enclosure that need to receive the reservation settings.

At block 666, the target drives may be selected to configure. For example, the adapter may choose the storage devices determined at block 664 to receive simultaneous reservation configuration commands.

At block 668, reservation settings may be received from the source drive. For example, the adapter may read the current reservation configuration from the source drive using a reservation status report request.

At block 670, the reservation settings may be sent to the target drives. For example, the adapter may transmit the reservation configuration parameters by broadcasting parallel configuration commands to the target drives.

At block 672, the target drives may receive and configure the settings. For example, each storage device may apply the received reservation settings to its namespaces in response to the configuration command by configuring and storing appropriate reservation configuration parameters, such as in a configuration register or page in memory.

At block 674, a determination may be made as to whether all acknowledgments have been received. For example, the adapter may wait for a confirmation message from each storage device indicating successful application of the settings. If any acknowledgements are not received, method 650 may return to block 670 to resend the configuration command. If an acknowledgement message is received from each device, method 650 may proceed to block 676.

At block 676, the runtime settings of the source drive may be verified. For example, the adapter may check the current configuration of the source drive to ensure no changes have occurred during the configuration process.

At block 678, a determination may be made if there are changes to the settings. For example, the adapter may compare the current settings of the source drive with the originally sent reservation settings. If no changes are present, method 650 may end and no further action may be taken. If yes, method 650 may proceed to block 680.

At block 680, changes may be synchronized to the target drives. For example, if any discrepancies are found, the adapter may send updated settings to all configured drives in another configuration command broadcast to ensure consistency across the system.

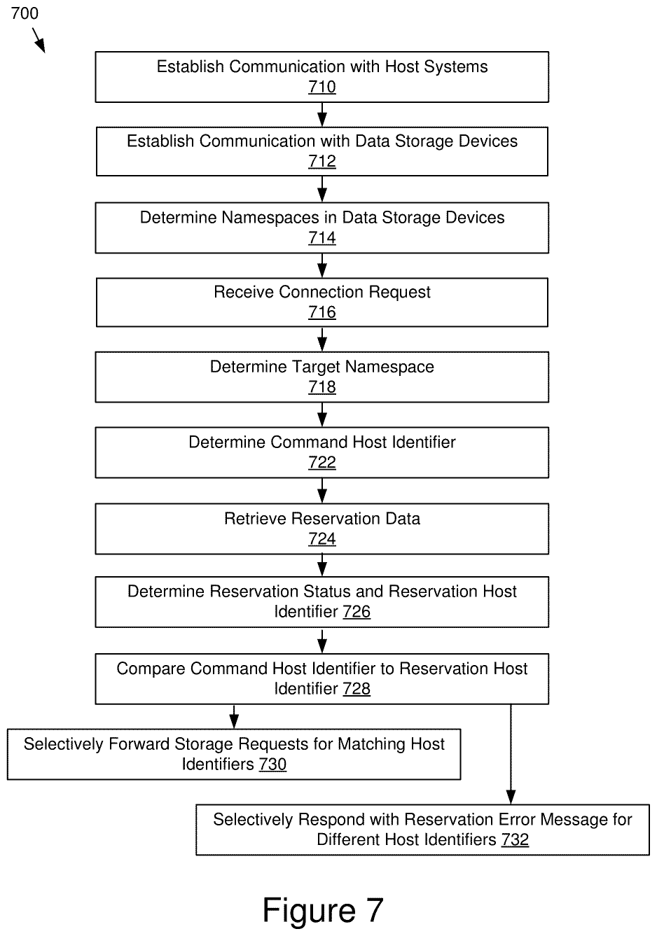

FIG. 7 illustrates a flowchart of a method 700 for managing connection requests and enforcing corresponding reservations in a storage system. The method may be executed by the storage interface adapters, such as adapters 216.1-216.6 or 312.1-312.2, in conjunction with the storage devices and hosts. The method may result in secure and controlled access to namespaces based on reservation status and host identifier. This method may enable the storage system to enforce access controls and maintain data integrity by verifying host identifiers against reservation data before allowing connections.

At block 710, communication with host systems may be established. For example, the adapter may initialize its host interface to accept connection requests from hosts.

At block 712, communication with data storage devices may be established. For example, the adapter may initialize each storage device in the storage enclosure to establish storage interface communications.

At block 714, namespaces in data storage devices may be determined. For example, the adapter may query each storage device to identify all available namespaces.

At block 716, a connection request may be received. For example, the adapter may receive a connection request from a host through its host interface.

At block 718, a target namespace may be determined. For example, the adapter may extract the namespace identifier from the connection request sent by the host.

At block 722, a command host identifier may be determined. For example, the adapter may extract the host identifier from the transport information associated with the connection request sent by host.

At block 724, reservation data may be retrieved. For example, the adapter may access its reservation data table to retrieve the reservation information for the target namespace.

At block 726, reservation status and reservation host identifier may be determined. For example, the adapter may analyze the retrieved reservation data to determine if the target namespace has an active reservation and, if so, which host holds that reservation.

At block 728, the command host identifier may be compared to the reservation host identifier. For example, the adapter may compare the host identifier from the connection request with the host identifier associated with the namespace reservation.

At block 730, a storage request may be selectively forwarded for matching host identifiers. For example, if the host identifiers match, the adapter may establish a host connection to the target namespace for receiving subsequent storage requests, such as host read or write commands for that namespace. Based on the reserved status of the host, the adapter may forward those storage requests to the allocated submission and completion queues for that host connection.

At block 732, a reservation error message may be selectively sent for different host identifiers. For example, if the host identifiers do not match, the adapter may still establish a host connection to the target namespace but will enforce the reservation type for a non-reserved host for any subsequent storage requests. Based on the non-reserved status of the host and reservation type, the adapter may generate and send a reservation conflict error message back to the requesting host, rather than submitting the storage request to the allocated queues.

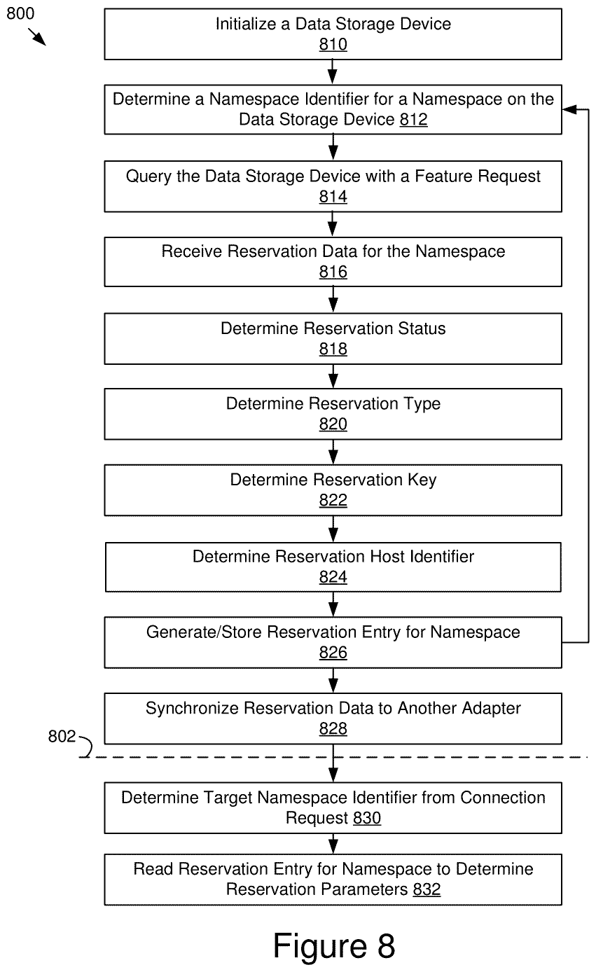

FIG. 8 illustrates a flowchart of a method 800 for managing reservation data in a storage system. The method may be executed by the storage interface adapters, such as adapters 216.1-216.6 or 312.1-312.2, in conjunction with the storage devices 120. The method may result in the establishment and synchronization of reservation data across multiple adapters and storage devices. This method may enable the storage system to maintain consistent and up-to-date reservation information, ensuring proper access control and data integrity across the system.

At block 810, a data storage device may be initialized. For example, the adapter may detect a newly connected storage device and initiate its initialization process.

At block 812, a namespace identifier for a namespace on the data storage device may be determined. For example, the adapter may query the storage device to identify all available namespaces and their corresponding identifiers.

At block 814, the data storage device may be queried with a feature request. For example, the adapter may send a get feature command to storage device to retrieve reservation information for a specific namespace.

At block 816, reservation data for the namespace may be received. For example, the storage device may respond to the feature request by sending the current reservation data for the queried namespace to the adapter.

At block 818, reservation status may be determined. For example, the adapter may analyze the received reservation data to determine if the namespace has an active reservation.

At block 820, reservation type may be determined. For example, the adapter may extract the reservation type information from the received data and/or associated configuration settings, which may indicate whether the reservation is exclusive or shared and write or read/write reservation.

At block 822, a reservation key may be determined. For example, the adapter may identify the unique key associated with the current reservation for the namespace.

At block 824, a reservation host identifier may be determined. For example, the adapter may extract the identifier of the host that currently holds the reservation for the namespace.

At block 826, a reservation entry for the namespace may be generated and stored. For example, the adapter may create a new entry in its reservation data table with the collected reservation information for the namespace.

At block 828, reservation data may be synchronized to another adapter. For example, the adapter may share the updated reservation data, such as an updated copy of the reservation data table, with at least the other adapter in the enclosure to ensure consistency across multiple adapters.

At block 830, a target namespace identifier may be determined from a connection request. For example, during an operating period 802 after the reservation datastore is populated through blocks 810-828, the adapter may receive a connection request from host and extract the target namespace identifier from the request.

At block 832, the reservation entry for the namespace may be read to determine reservation parameters. For example, the adapter may use the target namespace identifier to look up the corresponding reservation entry in its reservation data table and retrieve the relevant reservation parameters.

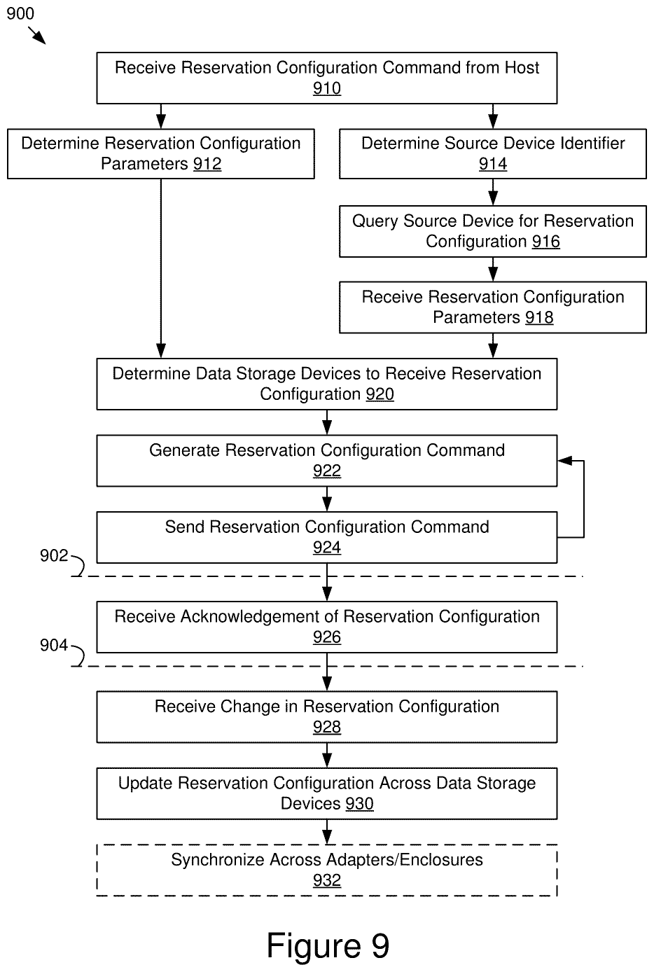

FIG. 9 illustrates a flowchart of a method 900 for managing reservation configuration in a storage system by having a storage interface controller replicate settings across data storage devices. The method may be executed by the storage interface adapters, such as adapters 216.1-216.6 or 312.1-312.2, in conjunction with the storage devices 120 and the hosts. The method may result in consistent and synchronized reservation configurations across multiple storage devices and adapters. This method may enable efficient propagation of reservation settings throughout the storage system, ensuring uniform access control and data integrity, as well as improving host system administrative efficiency.

At block 910, a reservation configuration command may be received from a host. For example, the adapter may receive a reservation configuration command from a host through its host interface.

At block 912, reservation configuration parameters may be determined. For example, the adapter may extract the reservation configuration parameters from the command received from the host.

At block 914, as an alternative to block 912, a source data storage device identifier may be determined. For example, the adapter may identify a specific storage device as the source for the reservation configuration based on source drive identifier parameter in the configuration command.

At block 916, the source device may be queried for reservation configuration. For example, the adapter may send a query to the identified source device, such as a reservation status report request, to retrieve its current reservation configuration.

At block 918, reservation configuration parameters may be received. For example, the adapter may receive the current reservation configuration parameters from the source device.

At block 920, data storage devices to receive the reservation configuration may be determined. For example, adapter 312.1 may identify all storage devices 120.n in the storage enclosure 210.4 that need to be updated with the new reservation configuration.

At block 922, a reservation configuration command may be generated. For example, the adapter may create a new reservation configuration command based on the parameters received from the host or the source device.

At block 924, the reservation configuration command may be sent. For example, the adapter may transmit the generated reservation configuration command to a target storage device. Method 900 may return to block 922 until commands have been generated and sent to all identified target storage devices.

At block 926, following a waiting period 902, an acknowledgment of the reservation configuration may be received. For example, the adapter may receive confirmation messages from each target storage device indicating successful application of the new reservation configuration.

At block 928, during an operating period 904 following initial configuration, a change in reservation configuration may be received. For example, the adapter may detect a modification in the reservation settings initiated by the host or receive updated configuration setting from the host.

At block 930, the reservation configuration may be updated across data storage devices. For example, the adapter may generate additional configuration commands to propagate the changed reservation configuration to all affected storage devices to maintain consistency.

At block 932, synchronization may selectively occur across adapters and enclosures. For example, in some configurations, the adapter may share the updated reservation configuration with other adapters in their enclosure and/or with adapters in other enclosures to ensure system-wide consistency and propagate configuration settings without requiring host commands for each device or namespace.

While at least one exemplary embodiment has been presented in the foregoing detailed description of the technology, it should be appreciated that a vast number of variations may exist. It should also be appreciated that an exemplary embodiment or exemplary embodiments are examples, and are not intended to limit the scope, applicability, or configuration of the technology in any way. Rather, the foregoing detailed description will provide those skilled in the art with a convenient road map for implementing an exemplary embodiment of the technology, it being understood that various modifications may be made in a function and/or arrangement of elements described in an exemplary embodiment without departing from the scope of the technology, as set forth in the appended claims and their legal equivalents.

As will be appreciated by one of ordinary skill in the art, various aspects of the present technology may be embodied as a system, method, or computer program product. Accordingly, some aspects of the present technology may take the form of an entirely hardware embodiment, an entirely software embodiment (including firmware, resident software, micro-code, etc.), or a combination of hardware and software aspects that may all generally be referred to herein as a circuit, module, system, and/or network. Furthermore, various aspects of the present technology may take the form of a computer program product embodied in one or more computer-readable mediums including computer-readable program code embodied thereon.

Any combination of one or more computer-readable mediums may be utilized. A computer-readable medium may be a computer-readable signal medium or a physical computer-readable storage medium. A physical computer readable storage medium may be, for example, but not limited to, an electronic, magnetic, optical, crystal, polymer, electromagnetic, infrared, or semiconductor system, apparatus, or device, etc., or any suitable combination of the foregoing. Non-limiting examples of a physical computer-readable storage medium may include, but are not limited to, an electrical connection including one or more wires, a portable computer diskette, a hard disk, random access memory (RAM), read-only memory (ROM), an erasable programmable read-only memory (EPROM), an electrically erasable programmable read-only memory (EEPROM), a Flash memory, an optical fiber, a compact disk read-only memory (CD-ROM), an optical processor, a magnetic processor, etc., or any suitable combination of the foregoing. In the context of this document, a computer-readable storage medium may be any tangible medium that can contain or store a program or data for use by or in connection with an instruction execution system, apparatus, and/or device.

Computer code embodied on a computer-readable medium may be transmitted using any appropriate medium, including but not limited to, wireless, wired, optical fiber cable, radio frequency (RF), etc., or any suitable combination of the foregoing. Computer code for carrying out operations for aspects of the present technology may be written in any static language, such as the C programming language or other similar programming language. The computer code may execute entirely on a user's computing device, partly on a user's computing device, as a stand-alone software package, partly on a user's computing device and partly on a remote computing device, or entirely on the remote computing device or a server. In the latter scenario, a remote computing device may be connected to a user's computing device through any type of network, or communication system, including, but not limited to, a local area network (LAN) or a wide area network (WAN), Converged Network, or the connection may be made to an external computer (e.g., through the Internet using an Internet Service Provider).

Various aspects of the present technology may be described above with reference to flowchart illustrations and/or block diagrams of methods, apparatus, systems, and computer program products. It will be understood that each block of a flowchart illustration and/or a block diagram, and combinations of blocks in a flowchart illustration and/or block diagram, can be implemented by computer program instructions. These computer program instructions may be provided to a processing device (processor) of a general purpose computer, special purpose computer, or other programmable data processing apparatus to produce a machine, such that the instructions, which can execute via the processing device or other programmable data processing apparatus, create means for implementing the operations/acts specified in a flowchart and/or block(s) of a block diagram.

Some computer program instructions may also be stored in a computer-readable medium that can direct a computer, other programmable data processing apparatus, or other device(s) to operate in a particular manner, such that the instructions stored in a computer-readable medium to produce an article of manufacture including instructions that implement the operation/act specified in a flowchart and/or block(s) of a block diagram. Some computer program instructions may also be loaded onto a computing device, other programmable data processing apparatus, or other device(s) to cause a series of operational steps to be performed on the computing device, other programmable apparatus or other device(s) to produce a computer-implemented process such that the instructions executed by the computer or other programmable apparatus provide one or more processes for implementing the operation(s)/act(s) specified in a flowchart and/or block(s) of a block diagram.

A flowchart and/or block diagram in the above figures may illustrate an architecture, functionality, and/or operation of possible implementations of apparatus, systems, methods, and/or computer program products according to various aspects of the present technology. In this regard, a block in a flowchart or block diagram may represent a module, segment, or portion of code, which may comprise one or more executable instructions for implementing one or more specified logical functions. It should also be noted that, in some alternative aspects, some functions noted in a block may occur out of an order noted in the figures. For example, two blocks shown in succession may, in fact, be executed substantially concurrently, or blocks may at times be executed in a reverse order, depending upon the operations involved. It will also be noted that a block of a block diagram and/or flowchart illustration or a combination of blocks in a block diagram and/or flowchart illustration, can be implemented by special purpose hardware-based systems that may perform one or more specified operations or acts, or combinations of special purpose hardware and computer instructions.

While one or more aspects of the present technology have been illustrated and discussed in detail, one of ordinary skill in the art will appreciate that modifications and/or adaptations to the various aspects may be made without departing from the scope of the present technology, as set forth in the following claims.

1. A storage system, comprising:
a first storage interface controller comprising:
a host interface configured to receive host storage commands from a plurality of host systems;
a storage device interface configured to direct host storage commands to at least one namespace in at least one data storage device;
a reservation datastore configured to comprise at least one reservation entry for the at least one namespace;
at least one memory; and
at least one processor configured to, alone or in combination:
receive, for a target namespace of the at least one namespace, a first connection request from a first host system from the plurality of host systems;
determine, from the first connection request:
a first host identifier for the first host system; and
a namespace identifier for the target namespace;
determine, using the namespace identifier for the target namespace to index the reservation datastore, a reservation status and a reservation host identifier from a reservation entry for the target namespace;
selectively forward, responsive to the first host identifier matching the reservation host identifier, a storage request from the first host system to a data storage device of the at least one data storage device, wherein the data storage device is configured to host the target namespace; and
selectively respond, responsive to the first host identifier not matching the reservation host identifier, to the storage request from the first host system with a reservation error message.

2. The storage system of claim 1, wherein
each reservation entry of the at least one reservation entry comprises:
a namespace identifier; and
a reservation key and a reservation host identifier for that namespace identifier.

3. The storage system of claim 2, wherein:
each reservation entry of the at least one reservation entry further comprises a reservation type for that namespace identifier; and
the reservation type is selected from:
exclusive write access;
exclusive read/write access;
shared write access; and
shared read/write access.

4. The storage system of claim 1, further comprising:
a second storage interface controller, wherein the at least one processor is further configured, alone or in combination, to synchronize a first copy of the reservation datastore in the first storage interface controller with a second copy of the reservation datastore in the second storage interface controller.

5. The storage system of claim 1, wherein the at least one processor is further configured to, alone or in combination:
query, prior to receiving the first connection request, the data storage device hosting the target namespace for the reservation status and the reservation host identifier for the target namespace;
receive, from the data storage device hosting the target namespace, the reservation status and the reservation host identifier for the target namespace; and
store, in the reservation entry for the target namespace, the reservation status and the reservation host identifier.

6. The storage system of claim 1, wherein the at least one processor is further configured to, alone or in combination:
initialize the data storage device hosting the target namespace;
receive, responsive to initializing the data storage device hosting the target namespace, the reservation status and the reservation host identifier for the target namespace; and
store, in the reservation entry for the target namespace, the reservation status and the reservation host identifier.

7. The storage system of claim 1, wherein:
the at least one data storage device comprises a plurality of data storage devices;
the at least one namespace comprises a plurality of namespaces; and
the at least one processor is further configured to, alone or in combination:
receive, for the plurality of data storage devices and the plurality of namespaces, a reservation configuration;
generate, based on the reservation configuration, at least one reservation configuration command for the plurality of namespaces; and
send, to each data storage device of the plurality of data storage devices, the at least one reservation configuration command.

8. The storage system of claim 7, wherein the at least one processor is further configured to, alone or in combination:
determine a source data storage device from the plurality of data storage devices; and
query, prior to receiving the reservation configuration, the source data storage device for the reservation configuration.

9. The storage system of claim 7, wherein the at least one processor is further configured to, alone or in combination, receive, from a host system of the plurality of host systems and prior to receiving the reservation configuration, a host configuration command comprising at least one set of parameters selected from:
a source data storage device identifier; and
the reservation configuration.

10. The storage system of claim 1, further comprising:
a data storage device enclosure comprising:
the at least one data storage device, wherein the at least one data storage device comprises a plurality of data storage devices;
the first storage interface controller, wherein the first storage interface controller is configured as a first interface adapter circuit; and
a second storage interface controller configured as a second interface adapter circuit.

11. A computer-implemented method, comprising:
storing, in a reservation datastore in a first storage interface controller and prior to receiving a first connection request, a plurality of reservation entries for a plurality of namespaces;
receiving, by the first storage interface controller and for a target namespace, a first connection request from a first host system from a plurality of host systems configured for communication with a plurality of data storage devices through the first storage interface controller;
determining, by the first storage interface controller and from the first connection request:
a first host identifier for the first host system; and
a namespace identifier for the target namespace;
determining, by the first storage interface controller and using the namespace identifier for the target namespace to index the reservation datastore, a reservation status and a reservation host identifier from a reservation entry for the target namespace;
selectively forwarding, by the first storage interface controller and responsive to the first host identifier matching the reservation host identifier, a storage request from the first host system to a data storage device of the plurality of data storage devices, wherein the data storage device hosts the target namespace; and
selectively responding, by the first storage interface controller and responsive to the first host identifier not matching the reservation host identifier, to the storage request from the first host system with a reservation error message.

12. The computer-implemented method of claim 11, wherein:
each reservation entry of the plurality of reservation entries comprises:
a namespace identifier corresponding to a namespace of a plurality of namespaces stored in the plurality of data storage devices; and
a reservation key and a reservation host identifier for that namespace identifier; and
the plurality of namespaces includes the target namespace.

13. The computer-implemented method of claim 12, further comprising:
reading, by the first storage interface controller and from the reservation entry, a reservation type for the target namespace, wherein:
each reservation entry of the plurality of reservation entries further comprises a reservation type for that namespace identifier; and
the reservation type is selected from:
exclusive write access;
exclusive read/write access;
shared write access; and
shared read/write access.

14. The computer-implemented method of claim 11, further comprising:
synchronizing, by the first storage interface controller, a first copy of the reservation datastore in the first storage interface controller with a second copy of the reservation datastore in a second storage interface controller.

15. The computer-implemented method of claim 11, further comprising:
querying, by the first storage interface controller and prior to receiving the first connection request, the data storage device hosting the target namespace for the reservation status and the reservation host identifier for the target namespace;
receiving, by the first storage interface controller and from the data storage device hosting the target namespace, the reservation status and the reservation host identifier for the target namespace; and
storing, by the first storage interface controller and in the reservation entry for the target namespace, the reservation status and the reservation host identifier.

16. The computer-implemented method of claim 11, further comprising:
initializing, by the first storage interface controller, the data storage device hosting the target namespace;
receiving, by the first storage interface controller and responsive to initializing the data storage device hosting the target namespace, the reservation status and the reservation host identifier for the target namespace; and
storing, by the first storage interface controller and in the reservation entry for the target namespace, the reservation status and the reservation host identifier.

17. The computer-implemented method of claim 11, further comprising:
receiving, by the first storage interface controller and for the plurality of data storage devices and a plurality of namespaces, a reservation configuration;
generating, by the first storage interface controller and based on the reservation configuration, at least one reservation configuration command for the plurality of namespaces; and
sending, by the first storage interface controller and to each data storage device of the plurality of data storage devices, the at least one reservation configuration command.

18. The computer-implemented method of claim 17, further comprising:
determining, by the first storage interface controller, a source data storage device from the plurality of data storage devices; and
querying, by the first storage interface controller and prior to receiving the reservation configuration, the source data storage device for the reservation configuration.

19. The computer-implemented method of claim 17, further comprising:
receiving, by the first storage interface controller and from a host system of the plurality of host systems, prior to receiving the reservation configuration, a host configuration command comprising at least one set of parameters selected from:
a source data storage device identifier; and
the reservation configuration.

20. A storage system comprising:
at least one processor;
at least one memory;
a plurality of data storage devices;
a host interface configured to receive host storage commands from a plurality of host systems;
a storage device interface configured to direct host storage commands to at least one namespace in the plurality of data storage devices;
a reservation datastore configured to comprise at least one reservation entry for the at least one namespace;
means, stored in the at least one memory for execution by the at least one processor, for receiving, for a target namespace of the at least one namespace, a first connection request from a first host system from the plurality of host systems;
means, stored in the at least one memory for execution by the at least one processor, for determining, from the first connection request:
a first host identifier for the first host system; and
a namespace identifier for the target namespace;
means, stored in the at least one memory for execution by the at least one processor, for determining, using the namespace identifier for the target namespace to index the reservation datastore, a reservation status and a reservation host identifier from a reservation entry for the target namespace;
means, stored in the at least one memory for execution by the at least one processor, for selectively forwarding, responsive to the first host identifier matching the reservation host identifier, a storage request from the first host system to a data storage device of the plurality of data storage devices, wherein the data storage device is configured to host the target namespace; and
means, stored in the at least one memory for execution by the at least one processor, for selectively responding, responsive to the first host identifier not matching the reservation host identifier, to the storage request from the first host system with a reservation error message.
